(19) United States
(12) Patent Application Publication
(10) Pub. No.: US 2002/0105197 A1
(43) Pub. Date: Aug. 8, 2002

(54) Guard for replaceably attaching to, and protecting, a slide of a vehicle from dings

(76) Inventor: Gregory R. Unterwagner, Woodstock, GA (US)

Correspondence Address: RICHARD L. MILLER, 12 Parkside Drive, Dix Hills, NY, 11746-4879, US

(21) Appl. No.: 09/777,294

(22) Filed: Feb. 6, 2001

(51) Int. Cl. B60R 19/42

(52) U.S. Cl. 293/128

(57) ABSTRACT

A guard for replaceably attaching to, and protecting, a side of a vehicle from dings. The guard includes a body, a magnet for replaceably attaching the body to the side of the vehicle, and a cushion for protecting the side of the vehicle from scratches from the magnet. The body is made of polyethylene foam for absorbing impacts, and is slender, elongated, semi-cylindrically-shaped, and has a rear surface that is flat and rectangular-shaped for facing the side of the vehicle, and a front surface that is semi-cylindrically-shaped for facing the ambient. The magnet is flexible for conforming to the side of the vehicle, and is a flat and rectangular-shaped strip that has a front surface that abuts against, conforms completely to, and is coincident with, the rear surface of the body, and a rear surface for facing the side of the vehicle. The cushion is made of felt and is a flat and rectangular-shaped strip that has a front surface that abuts against, conforms completely to, and is coincident with, the rear surface of the magnet, and a rear surface for abutting against the side of the vehicle.

### BACKGROUND OF THE INVENTION

1. Field of the Invention:

The present invention relates to a guard. More particularly, the present invention relates to a guard for replaceably attaching to, and protecting, a side of a vehicle from dings.

2. Description of the Prior Art:

Numerous innovations for vehicle protective body moldings have been provided in the prior art that will be described. Even though these innovations may be suitable for the specific individual purposes to which they address, however, they differ from the present invention.

A FIRST EXAMPLE, U.S. Pat. No. Des. 304,711 to Clarke teaches the ornamental design for a clip-on automobile body side molding.

A SECOND EXAMPLE, U.S. Pat. No. 4,498,697 to McGlone et al. teaches a molded plastic or rubber tube with an adhesively applied flexible magnet that can be magnetically attached to the sides of any metal vehicle for the purpose of protection against being damaged by impacts from hard objects or adjacent vehicles in a parking situation. Further, the molding can be secured to the vehicle by a wire clip that surrounds the diameter of the molding and has a projection on the magnet side of the molding that fits between the door and the door jam of a vehicle which secures the clip and therefore the molding to the vehicle when the door is closed and locked.

A THIRD EXAMPLE, U.S. Pat. No. 4,573,288 to Adell teaches a magnetic door edge guard for the trailing edge of a swinging metal closure such as an automobile door that comprises an elongate non-metallic body of generally U-shaped cross section which contains a plurality of permanently magnetized elements for attaching the edge guard magnetically to the trailing edge of the swinging metal closure. In one embodiment the permanently magnetized elements comprise wires extending lengthwise of the non-metallic body. In another embodiment the permanently magnetized elements comprise metal fragments distributed throughout the extent of the nonmetallic body.

A FOURTH EXAMPLE, U.S. Pat. No. 4,707,008 to Falco teaches a molded or extruded material made of plastic or rubber which forms the exterior portion of the body molding which can come in contact with other objects. On the underside portion of the body molding, vinylized magnets and suction cups are attached such that the body molding can be releasably attached to a ferrous or non-ferrous vehicle. The molding is sufficient in length and width to adequately protect a selected portion of the vehicle. Locking device mechanisms are recessed within the underside portion of the body molding which, when affixed to the jam of a door on a vehicle, prevent theft of the body molding while it is attached to the side of the vehicle.

A FIFTH EXAMPLE, U.S. Pat. No. 5,071,181 to Wagner teaches a resilient vehicle side bumper having an elongated body member and fastening members extended from forward and rearward end portions of the elongated body member for releasably securing the side bumper to the vehicle. A first fastening member is included with an elastic member for connecting the first fastening member to the elongated body member, the elastic member further capable of expanding sufficiently to allow the first fastening member to be interconnected with a second fastening member mounted on the vehicle. A locking device is included which, when engaged, blocks the first fastening member from undesired disconnection from the second fastening member. A fastening member attached to the end of the elastic member is comprised of a cylindrical body having an arcuate passageway for receipt of the elastic member. The arcuate passageway extends from an entrance port in an outer side edge of the cylindrical body to an exit port in the outer side edge of the cylindrical body.

It is apparent that numerous innovations for vehicle protective body moldings have been provided in the prior art that are adapted to be used. Furthermore, even though these innovations may be suitable for the specific individual purposes to which they address however, they would not be suitable for the purposes of the present invention as heretofore described.

### SUMMARY OF THE INVENTION

ACCORDINGLY, AN OBJECT of the present invention is to provide a guard for replaceably attaching to, and protecting, a side of a vehicle from dings that avoids the disadvantages of the prior art.

ANOTHER OBJECT of the present invention is to provide a guard for replaceably attaching to, and protecting, a side of a vehicle from dings that is simple and inexpensive to manufacture.

STILL ANOTHER OBJECT of the present invention is to provide a guard for replaceably attaching to, and protecting, a side of a vehicle from dings that is simple to use.

BRIEFLY STATED, STILL YET ANOTHER OBJECT of the present invention is to provide a guard for replaceably attaching to, and protecting, a side of a vehicle from dings. The guard includes a body, a magnet for replaceably attaching the body to the side of the vehicle, and a cushion for protecting the side of the vehicle from scratches from the magnet. The body is made of polyethylene foam for absorbing impacts, and is slender, elongated, semi-cylindrically-shaped, and has a rear surface that is flat and rectangular-shaped for facing the side of the vehicle, and a front surface that is semi-cylindrically-shaped for facing the ambient. The magnet is flexible for conforming to the side of the vehicle, and is a flat and rectangular-shaped strip that has a front surface that abuts against, conforms completely to, and is coincident with, the rear surface of the body, and a rear surface for facing the side of the vehicle. The cushion is made of felt and is a flat and rectangular-shaped strip that has a front surface that abuts against, conforms completely to, and is coincident with, the rear surface of the magnet, and a rear surface for abutting against the side of the vehicle.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIG. 1 is a diagrammatic perspective use of the present invention in use;

FIG. 2 is an enlarged exploded diagrammatic perspective view of the area generally enclosed by the dotted curve identified by arrow 2 in FIG. 1 of the present invention; and

FIG. 3 is an enlarged diagrammatic cross sectional view taken on line 3-3 in FIG. 2.

### LIST OF REFERENCE NUMERALS UTILIZED IN THE DRAWING

10 guard of present invention for replaceably attaching to, and protecting, side 12 of vehicle 14 from dings

12 side of vehicle 14

14 vehicle

16 body for replaceably attaching to, and protecting, side 12 of vehicle 14 from dings

18 magnet for replaceably attaching body 16 to side 12 of vehicle 14

20 cushion for protecting side 12 of vehicle 14 from scratches from magnet 18

22 rear surface of body 16 for facing side 12 of vehicle 14

24 front surface of body 16 for facing ambient

26 front surface of magnet 18

28 rear surface of magnet 18 for facing side 12 of vehicle 14

30 front surface of cushion 20

32 rear surface of cushion 20 for abutting against side 12 of vehicle 14

### DETAILED DESCRIPTION OF THE PREFERRED EMBODIMENT

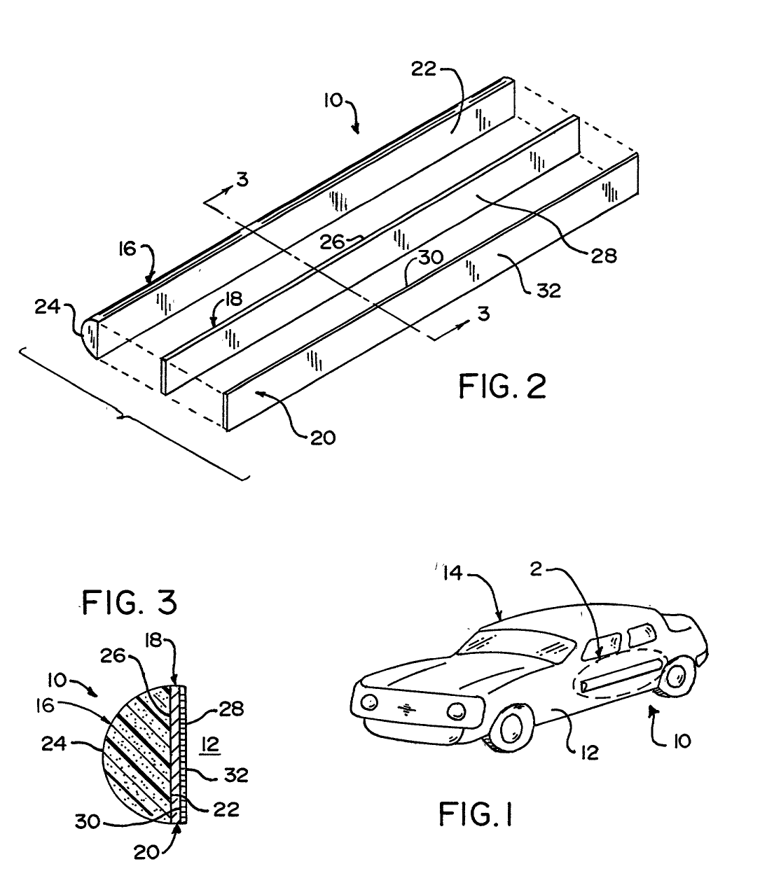

Referring now to the figures, in which like numerals indicate like parts, and particularly to FIG. 1, the guard of the present invention is shown generally at 10 for replaceably attaching to, and protecting, a side 12 of a vehicle 14 from dings.

The configuration of the guard 10 can best be seen in FIGS. 2 and 3, and as such, will be discussed with reference thereto.

The guard 10 comprises a body 16 for replaceably attaching to, and protecting, the side 12 of the vehicle 14 from dings, and a magnet 18 that is attached to the body 16 for replaceably attaching the body 16 to the side 12 of the vehicle 14.

The guard 10 further comprises a cushion 20 that is attached to the magnet 18 for protecting the side 12 of the vehicle 14 from scratches from the magnet 18.

The body 16 is slender, elongated, and semi-cylindrically-shaped.

The body 16 has a length, a width, a rear surface 22 that is flat and rectangular-shaped for facing the side 12 of the vehicle 14, and a front surface 24 that is semi-cylindrically-shaped and opposes, but meets, the rear surface 22 of the body 16 for facing the ambient.

The body 16 is made of polyethylene foam for absorbing impacts.

The magnet 18 is a flat and rectangular-shaped strip.

The magnet 18 has a length that is equivalent to the length of the body 16, a width that is equivalent to the width of the body 16, a front surface 26 that abuts against, conforms completely to, and is coincident with, the rear surface 22 of the body 16, and a rear surface 28 that opposes the front surface 26 of the magnet 18 for facing the side 12 of the vehicle 14.

The magnet 18 is flexible for conforming to the side 12 of the vehicle 14.

The cushion 20 is a flat and rectangular-shaped strip.

The cushion 20 has a length that is equivalent to the length of the magnet 18, a width that is equivalent to the width of the magnet 18, a front surface 30 that abuts against, conforms completely to, and is coincident with, the rear surface 28 of the magnet 18, and a rear surface 32 that opposes the front surface 30 of the cushion 20 for abutting against the side 12 of the vehicle 14.

The cushion 20 is made of felt.

It will be understood that each of the elements described above, or two or more together, may also find a useful application in other types of constructions differing from the types described above.

While the invention has been illustrated and described as embodied in a guard for protecting a side of a vehicle, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A guard for replaceably attaching to, and protecting, a side of a vehicle from dings, comprising:
a) a body for replaceably attaching to, and protecting, the side of the vehicle from dings; and
b) a magnet attached to said body for replaceably attaching said body to the side of the vehicle.

2. The guard as defined in claim 1; further comprising a cushion attached to said magnet for protecting the side of the vehicle from scratches from said magnet.

3. The guard as defined in claim 1, wherein said body is slender, elongated, and semi-cylindrically-shaped.

4. The guard as defined in claim 1, wherein said body has:
a) a length;
b) a width;
c) a rear surface that is flat and rectangular-shaped for facing the side of the vehicle; and
d) a front surface that is semi-cylindrically-shaped and opposes, but meets, said rear surface of said body for facing the ambient.

5. The guard as defined in claim 1, wherein said body is made of polyethylene foam for absorbing impacts.

6. The guard as defined in claim 1, wherein said magnet is a flat and rectangular-shaped strip.

7. The guard as defined in claim 4, wherein said magnet has:
a) a length that is equivalent to said length of said body;
b) a width that is equivalent to said width of said body;
c) a front surface that abuts against, conforms completely to, and is coincident with, said rear surface of said body; and
d) a rear surface that opposes said front surface of said magnet for facing the side of the vehicle.

8. The guard as defined in claim 1, wherein said magnet is flexible for conforming to the side of the vehicle.

9. The guard as defined in claim 2, wherein said cushion is a flat and rectangular-shaped strip.

10. The guard as defined in claim 7, wherein said cushion has:
a) a length that is equivalent to said length of said magnet;
b) a width that is equivalent to said width of said magnet;
c) a front surface that abuts against, conforms completely to, and is coincident with, said rear surface of said magnet; and
d) a rear surface that opposes said front surface of said cushion for abutting against the side of the vehicle.

11. The guard as defined in claim 2, wherein said cushion is made of felt.
